(19) United States
(12) Patent Application Publication
(10) Pub. No.: US 2021/0051019 A1
(43) Pub. Date: Feb. 18, 2021

(54) BLOCKCHAIN COMMUNICATION ARCHITECTURE

(71) Applicant: Realtime Applications, Inc., Birmingham, AL (US)

(72) Inventors: John Martin Hyde, Birmingham, AL (US); Steven Knol Janes, JR., Birmingham, AL (US)

(73) Assignee: Realtime Applications, Inc., Birmingham, AL (US)

(21) Appl. No.: 16/847,440

(22) Filed: Apr. 13, 2020

Related U.S. Application Data
(60) Provisional application No. 62/886,217, filed on Aug. 13, 2019.

(51) Int. Cl. H04L 9/32; H04L 29/06; G06F 16/951; G06F 16/23

(52) U.S. Cl. CPC H04L 9/3239; H04L 9/3297; H04L 2209/38; G06F 16/951; G06F 16/2358; H04L 69/162

(57) ABSTRACT

Multiple blockchains are created to interact/communicate with each other, each blockchain containing aggregated information from detailed transaction logs from existing transaction managers, the aggregation being performed agnostic of data source. The data aggregated on the blockchains is organized, like a database, into tables and records by the use of crawlers that exist on the top of blockchains. Event describers are tuned to focus on particular events, such as whether a record being built by the crawlers meets a set criteria. The event describers may collect data meeting the criteria and push information gained to a socket, creating a new spinoff blockchain. A completed audit trail of time-capsuled data can be created in an existing system without the need for prerequisite programming of version control.

This application claims priority to U.S. Provisional Patent Application No. 62/886,217 entitled “Blockchain Communication Architecture” and filed on Aug. 13, 2019.

### BACKGROUND

Conventional databases, while being customizable, are typically not set up to ensure data integrity. Data stored in a database is centralized, highly modifiable, and can easily be rewritten or deleted by structured queries (such as SQL queries), computer instructions or programs, or by actions taken by other human and computing entities. Use of a database does not inherently include versioned or tracked data records. As a result, once data is modified, the unmodified version may be difficult or impossible to recover. As an alternative to conventional databases, modern computing solutions are sometimes designed to store encrypted data on a blockchain. Blockchains have been used in a variety of applications, such as the Internet of things (IoT), finance, healthcare, and many others. In a conventional blockchain implementation, a participating computing node may record a new transaction by appending a new block with additional data to the existing blockchain. Blocks in a blockchain are linked to earlier blocks and the integrity of the data within a block is proved (e.g., by a hash, digital signature, or other mechanism) so as to serve as an immutable record of events/transactions. The code may also define characteristics of the blocks, such as a consistent block size. In some implementations, a new block in a blockchain may be added for each occurring event or transaction (or multiple events may be added) until the block reaches a specified block size. A hash digest of the content of the block and the header of the previous block in the chain may be added as the first event in the new block. Each block may be secured by the application of a consensus protocol, such as a proof of work, proof of useful work, proof of stake, or the like. Integrity of data stored on the blockchain is thus ensured, with each change or revision made to the data being accounted for. The blockchain is thereafter stored in its entirety in memory at each participating computing node.

Transactional management solutions may use such a conventional blockchain as the sole data source for a system, that is, as a replacement for a database. One problem occurring with such a solution is that blockchains that have fixed block lengths may not be useable for variable length data. Further, the switch from database to blockchain may require extensive development and customization—an expensive and time consuming process—as there is no conventional out-of-the-box user interface that hooks up to blockchain.

What is more, in an enterprise environment, decentralized blockchains are simply very difficult to implement. A first problem is that of data privacy. To ensure integrity, the blockchain may need to be set up as a permissioned private blockchain, such that an enterprise controls resources and access to the blockchain and restrictions are placed on participants who can write data onto the blockchain and/or what transactions they can participate in. Additionally, there may be an expensive GPU cost for the mining involved in transaction management, while the private blockchain system may provide no reward to participants for mining blocks.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 depicts an environment implementing a blockchain communication architecture in accordance with some embodiments of the present disclosure.

FIG. 2 is a diagram of a data flow through a blockchain communication architecture in accordance with some embodiments of the present disclosure.

FIG. 3A is a diagram of a data flow through a blockchain communication architecture in accordance with some embodiments of the present disclosure.

FIG. 3B is a diagram of a data flow through a blockchain communication architecture in accordance with some embodiments of the present disclosure.

FIG. 4 is a flow chart of a process for blockchain data mining in a blockchain communication architecture in accordance with some embodiments of the present disclosure.

FIG. 5 is a diagram of a data flow through a blockchain communication architecture in accordance with some embodiments of the present disclosure.

In the figures, the left-most digit(s) of a reference number identifies the figure in which the reference number first appears. The use of the same reference numbers in different figures indicates similar or identical items or features. Moreover, multiple instances of the same part are designated by a common prefix separated from the instance number by a dash. The drawings are not to scale.

### DETAILED DESCRIPTION

The methods and systems described herein may be used to securely store data captured from an existing platform's created application/program/process, an existing system, or an Internet of things (IoT) device to a blockchain. The blockchain is crawled to collect and organize the data to be communicated via push (multi-casted) or pull (REST API) to a current/future user or entity. In addition, the crawling can be set to aggregate event data that addresses one or more system rules or queries, and describes the qualifying data onto one or more blockchains to be crawled and utilized in the same manner. In an exemplary embodiment, a blockchain communication architecture is established such that a blockchain is not built around transactions, but rather, around the data already generated by existing systems. The blockchain is created based on already-captured data (e.g., data from sensor devices, apps created on low or no code platforms, environmental health and safety management systems, input fault or risk information, etc.) so as to integrate the blockchain with an existing system platform with one or more existing transaction managers. The blockchains are created based on the data produced/collected by the transaction manager at a device, and may be altered in size and/or content based on such data.

In some embodiments, the blockchain communication architecture uses an existing database as an interface to collect information. Trusted builder components (builders) tie into existing transaction managers to push or pull data from databases, acting as data producers that generate transaction logs. As one example, a transaction log (or event log) may be a log of data generated by and received from an IoT device in a centralized or decentralized environment. To do this, the builder components may establish socket connections (TCP (transmission control protocol) or UDP (user datagram protocol)) and use XML, JSON, or any other known medium for data interchange (including native system solutions) with the data source. Where detailed transaction data is exchanged between the devices, transaction logs may be generated and used as sources for multiple blockchains to aggregate data, the blockchains interacting and communicating with each other. In other implementations, rather than customized builders that generate transaction logs, the blockchains can be built from any data source that produces detailed logs on its own. By these means, the blockchains are built on top of existing applications with their own data sources (typically databases), rather than taking the place of these disparate data sources. Because the blockchain communication architecture described herein uses an immutable blockchain structure generated by trusted sources (builders), it provides mechanisms to ensure data integrity, accountability for changes, and communication between computing nodes.

In an embodiment, the data aggregated on the blockchains (e.g., records or transaction-based information) is automatically organized into tables and records and is time-capsuled (as it would be in a traditional database), so that a set of records can be pulled for any point in time and complete (or partial) historical audit trails can be obtained for every change made to any record. This organization is done by modules (crawlers) that exist on the top of blockchains. In some embodiments, the crawlers exist on the blockchain in a many-to-one relationship, however, in other embodiments, a single crawler may correspond to a single blockchain. A crawler, in obtaining information from the blockchain, can be set to focus on certain types of data, such as a time frame of interest, or may search for data that meets any of a variety of criteria.

In the exemplary architecture, data is retrieved from the crawlers through the use of Javascript event describers/event listeners that point to a crawler. The event describers are tuned to focus on particular events, such as whether a record being built by the crawlers meets a set criteria. The event describers may collect this data and push information gained to a socket, creating a new spinoff blockchain with a filtered set of data.

Because the data on the blockchains are organized into readable records, data can be broadcast to dashboards, learning modules, assistants, and the like in a visualized format (that is, human-readable). The exemplary architecture includes a multicaster that transmits data obtained by the crawlers to any listener via sockets, such as web sockets for dashboards or TCP sockets for assistants, learning modules, or AI solutions. APIs can be used to pull information about data transactions or records and to version each record.

Data on the blockchain may be published by a publisher implemented and configured to point to a specified crawler and to publish a user interface (e.g., GUI) with the data that is on the associated spinoff blockchain. The publishing may be done with Wikipedia-style indexing and analytics, allowing complete table and record breakdown showing relevant time-capsuled data.

Through this interaction, users may access aggregate information. Learning algorithms can be applied thereto to develop detailed analytical information such as root cause analysis, failure analysis, risk analysis, event and incident analysis, to-dos or action items, notifications, record data capture, and/or data or personnel management, among many other things.

The systems and methods described herein provide substantial improvements over existing systems, particularly in enterprise implementations. Unlike conventional solutions, the systems and methods described herein are tuned, regulated, or set around an existing system's variable length data and other needs, therefore avoiding the need for excessive customization or changes to existing industry systems and improving the cost, speed, and ease of incorporation. This is because, through the architectures described herein, a system does not have to be specially programmed (or an existing system reprogrammed) around a backend blockchain. Unlike a conventional application of the blockchain in which the block size and characteristics may be set, here, the blockchain structure is designed flexibly to automatically adjust to the existing system, where the system creates the information (and model or structure) needed in the blockchain.

In addition, in the solutions described herein, a completed audit trail of time-capsuled data is created without the need for prerequisite programming or version control in a database implementation, which conventionally would be a highly labor and resource intensive process. Unlike conventional blockchain implementations that may require different reporting solutions for data collected from different data sources, here, multiple blockchains are used to aggregate data from a variety of different data sources (such as different devices, and differently-functional devices) into single, limited-scope (or otherwise filtered) aggregated repositories. The multiple blockchains may then communicate desired portions of that aggregated data to all desired recipients, whether dashboard, learning modules, assistants, or any other existing system.

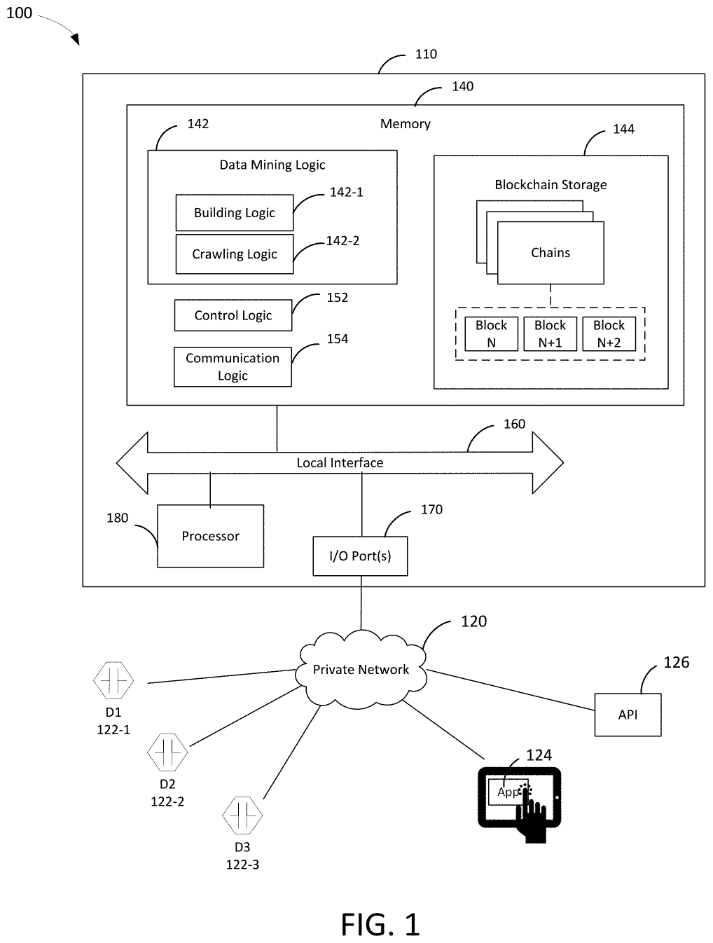

FIG. 1 illustrates an exemplary environment 100 for a blockchain communication system 110 (also referred to herein as system 110). In one embodiment, system 110 is illustrated as a computing device, however, such is only one example of a suitable operating environment. Certain exemplary components of system 110 are described in greater detail below. System 110 may communicate via one or more I/O ports 170 with remote devices over a network 120. Network 120 may be one or more private networks (as illustrated) or in other embodiments, one or more public networks or any combination of public and private networks. Network 120 may comprise any of one or more network types, such as a local area network (e.g., an intranet), a wide area network (such as the Internet), a terrestrial microwave or satellite links network, a LAN, a WAN, a cellular network (e.g., LTE, HSPA, 3G, and other cellular technologies) or another type of wireless network, such as Wi-Fi, Bluetooth, Bluetooth Low Energy, and/or other close-range wireless communications, a wired network, such as fiber optics and Ethernet, or any other such network, or any combination thereof. In some embodiments, the network 120 is a private enterprise network or private cloud, and in others, the network 120 may be the Internet and information may be communicated between system components in an encrypted format such as by a transport layer security (TLS) or secure socket layer (SSL) protocol and may use the transmission control protocol/Internet protocol (TCP/IP) for communication.

System 110 may receive data from and/or send data to one or more devices or applications over network 120. In particular, FIG. 1 illustrates one or more devices D1 (122-1), D2 (122-2), and D3 (122-3), which may be, for instance, wired or wireless devices, such as sensors, devices in an environmental health and safety management system, vehicles or drones, or any other devices capable of capturing data and transmitting it to system 110 over the network 120. Also connected to network 120 are one or more apps 124, or other entities or devices exchanging data over the network via one or more application programming interfaces (APIs) 126.

FIG. 1 illustrates certain components of system 110 in accordance with some embodiments of the present disclosure. Initially, the system 110 may include a memory 140. As used herein, memory 140 may refer to any suitable storage medium, either volatile and non-volatile (e.g., RAM, ROM, EPROM, EEPROM, SRAM, flash memory, disks or optical storage, magnetic storage, or any other tangible or non-transitory medium) that stores information that is accessible by a processor. Memory 140 may store instructions and data used in the systems and methods described herein. While FIG. 1 illustrates a single discrete memory 140, it will be understood that the embodiments described herein are not limited to any particular arrangement and that other embodiments may store information in one combined memory, or in one or more memories, some local to the other components illustrated in FIG. 1 and/or some shared with, or geographically located near, other remote computing systems.

The illustrated embodiment depicts a number of modules stored in memory 140, specifically, data mining logic 142 (including building logic 142-1 and crawling logic 142-2), control logic 152, and communication logic 154. These depicted modules may variously represent one or more algorithms, computational models, decision making rules or instructions, or the like implemented as software code or computer-executable instructions (i.e., routines, programs, objects, components, data structures, etc.) that, when executed by one or more processors 180, program the processor(s) to perform the particular functions of their respective logic. These modules are depicted in FIG. 1 as several discrete components, each labelled as an individual “logic”, however, in various embodiments, the functions of each respective logic may be executable on their own or as part of one or more other modules; that is, any configuration of the depicted logical components may be used, whether implemented by hardware, software, firmware, or any combination thereof. In some embodiments, communication logic 154 may use APIs to obtain stored data, however, other methods of data collection may alternatively be used such as one or more software development kits, which may include, e.g., APIs, web APIs, tools to communicate with embedded systems, or any other appropriate implementation.

While, in the exemplary embodiment, each logic is depicted as part of system 110, these logical components need not be so configured, and in other embodiments, other configurations of the various components, within system 110 or distributed over one or more computing systems, are possible. The depicted logics may be variously implemented in software, hardware, firmware or any combination thereof. In the exemplary system 110 shown in FIG. 1, logics 142, 142-1, 142-2, 152, and 154 are implemented in software and are stored in memory 140 of the system 110. Note that these components, when implemented in software, can be stored and transported on any non-transitory computer-readable medium for use by or in connection with an apparatus (e.g., a microprocessor) that can execute instructions. In the context of this disclosure, a “computer-readable medium” can be any device or system that can contain or store a computer program for use by or in connection with an instruction execution apparatus.

In one embodiment, building logic 142-1 is generally directed to building/deploying a plurality of blockchains based on and storing data obtained from remote devices over network 120, and crawling logic 142-2 is generally directed to organizing data on those blockchains and aggregating that data over multiple chains based on one or more system-defined or user-defined rules. The aggregated (and in some embodiments filtered) data may be transmitted, via network 120, to users (via application 124, API 126) for example as a dashboard or other summary data.

The logics of the exemplary system 110 depicted in FIG. 1 may be executed by one or more conventional processing elements 180, such as one or more central processing units (CPU), digital signal processors (DSP), graphics processing units (GPU), application-specific integrated circuits (ASICs), field-programmable gate arrays (FPGAs), and/or microprocessors programmed with software or firmware, other specialized processor or combination of processors, or other circuitry that communicates to and drives the other elements within the system 110 via a local interface 160, which can include at least one data bus, such as 12C, SPI, USB, UART, or GPIO. As an example, the processor 180 may execute instructions of software stored in memory 140. While FIG. 1 illustrates one processor 140 that implements all of the various logics in the system 110, it is possible in other embodiments for the system 110 to employ multiple processors. In some embodiments, the processing of system 120 is not limited to being performed by a processing element connected to the local interface 160, but instead, any portion of processing in support of the various logics may be distributed over one or more computer systems that may be remotely located. For instance, system 110 may include physical computing devices residing at a particular location or may be deployed, wholly or partially, in a cloud computing network environment. In this description, “cloud computing” may be defined as a model for enabling network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). In some embodiments, the processor 180 may comprise an artificial neural network or other type of configuration for performing machine learning functions based on instructions stored in memory 140. In one embodiment, each builder module used by building logic 142-1 may be run on a uniquely assigned microcontroller, though such is merely exemplary and other configurations are possible in other embodiments.

FIG. 1 also illustrates a blockchain storage 144 in memory 140, in which one more blockchains may be stored, each comprising at least one block. In general, a blockchain may be understood to comprise a plurality of “blocks” (e.g., block N, block N+1, block N+2, . . . ) each storing data along with a hash code associated with that data, a previous hash, a block index, and a transaction index, though other content may be stored in the blockchain in other embodiments, typically in an encrypted form.

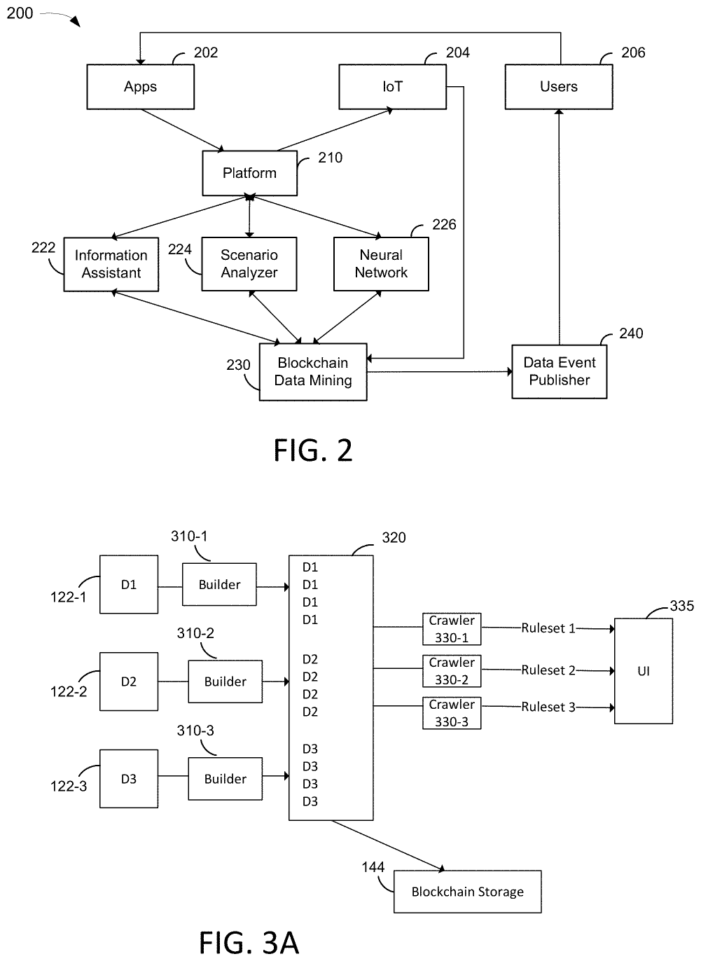

FIG. 2 illustrates a high-level depiction of an environment 200 in which services are provided by a system 110 in accordance with an exemplary embodiment. In the blockchain communication architecture described herein, it may be generally understood that a blockchain is not built around transactions, but rather, is built around (and based on) data collected from existing devices with their own respective data collection and/or transaction managers. FIG. 2 depicts IoT devices 204 (though other embodiments may use data from any of a variety of existing data sources), apps 202, and users 206 (each having, e.g., a device such as a laptop, mobile device, tablet, or other computing device that may send data to and/or receive data from the system 110). Event data from devices 204 (e.g., from transaction logs) is collected and stored by builders (described in greater detail below) of the blockchain data mining component 230. The blockchain data mining component 230 validates and secures the stored data in an immutable, versioned manner, building blockchains from generated log data. Blockchain data mining component 230 may also include one or more crawlers (described in greater detail below) on top of the blockchain that organize data on the blockchains into tables or other organized data structures. These crawlers may also be used to aggregate the data on the chains into filtered datasets (on discrete blockchains) on which meaningful targeted analyses can be conducted. The crawlers additionally transmit (e.g., multicast) the data out via one or more sockets for presentation of analytical data to users via dashboards. In particular, blockchain data mining component 230 may transmit data to data event publisher 240, which may be used to visualize the information on the blockchain (along with metadata) and provide that information, information about the audit trail, and/or other archived or historical information (e.g., by pulling information about historical records from the blockchain(s) via JSON or XML) for reporting to one or more users 206 on dashboards, assistants, AI, or other tools for data visualization and/or review.

A platform 210 (in some embodiments, a low code platform, though any appropriate software development platform, application portal, or the like may be used) may use the data from blockchain data mining component 230 via a variety of tools. Platform 210 may be generally understood to process information from one or more applications 202, at an enterprise level, application level, device level, or at any of a variety of levels of granularity. Platform 210 may act as the interaction point for the environment 200, allowing for the creation, distribution, and/or collection of data, and offering tools to act in response to various scenarios, such as notifications, alerts, reports, and the like. Platform 210 may rely upon information assistant 222, scenario analyzer 224, and/or neural network 226 to obtain or receive information from blockchain data mining component 230 and to intelligently analyze that data (for example in a learning manner) to detect points of action to be taken, recommendations, notifications, or other messages from the platform 210 to one or more users or entities. Information assistant 222 may, for example, analyze current and historical data to recognize similarities, warnings, and/or solutions. Scenario analyzer 224 may generate analytics and/or baselines to allow the apps 202 to present information to users to information and/or guide. Neural network 226 may be used to parameterize and train one or more predictive algorithms, the output(s) of which may be used to inform users and/or avoid faults or undesirable conditions.

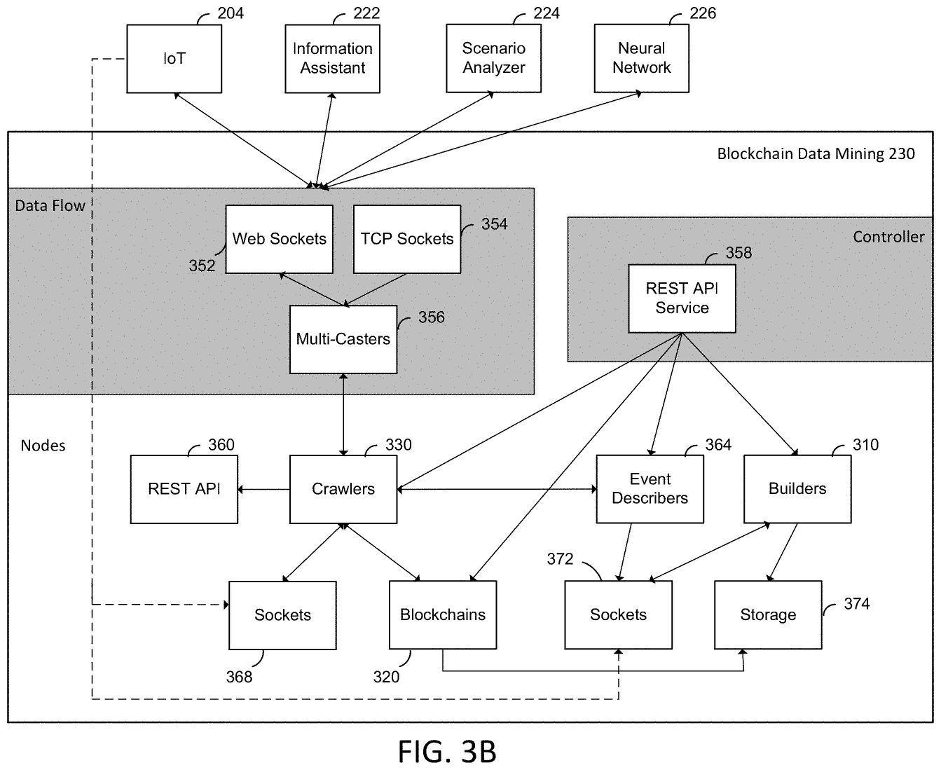

FIG. 3 illustrates a general data flow between the IoT devices (122-1, 122-2, and 122-3), builders, crawlers, and the transmission of any generated output to a user. FIG. 3 illustrates three builders 310-1, 310-2, and 310-3 and three IoT devices, though any appropriate number may be possible in different embodiments. Each builder is a trusted source (recognized as a verified source by all nodes on the private network 120) that ties into one or more existing system transaction managers at a respective IoT device D1, D2, and D3 to push or pull data from databases or other data structures. The information stored in the databases may be, for example, event data from a network device or application that generates actions which could be regarded as an event, such as a routine action, data captures, or sensing, a fault or error, a login action from a user or server, a firewall message, a security message from an application, an administrative task, or any other type of action taken or event occurring. A log may be of any size and any appropriate level of detail, and may include any number of one or more individual events/messages.

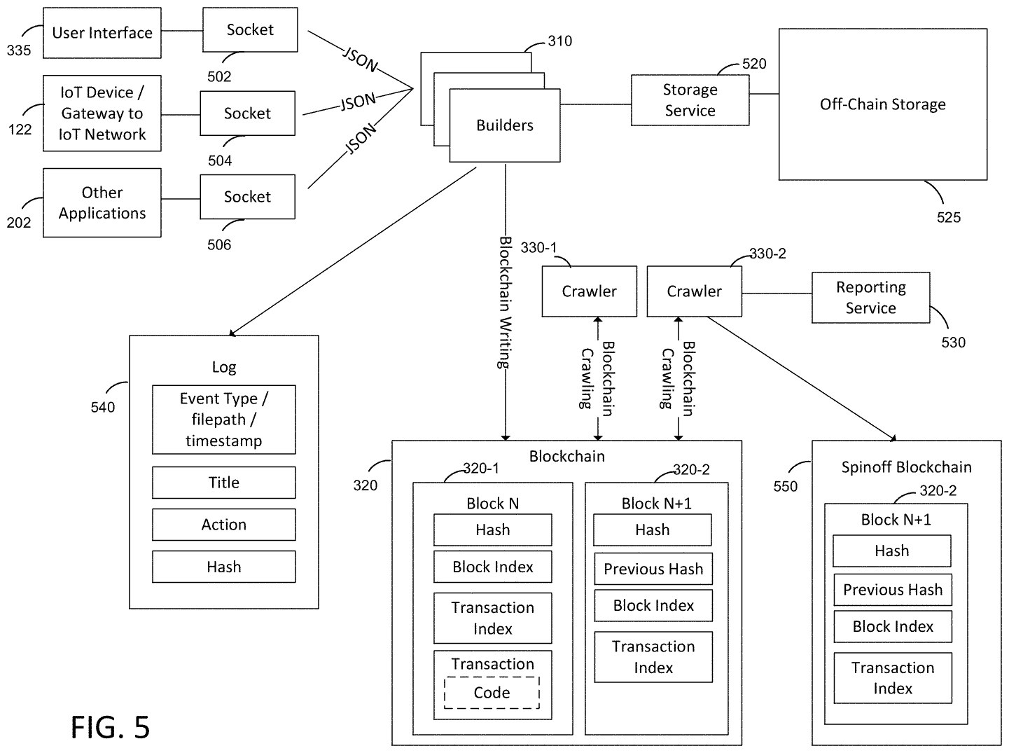

To obtain this event data, a builder 310-1 (though builders 310-2 and 310-3 may be understood to function in a similar manner) may establish one or more socket connections (e.g., TCP, UDP) with the data source. This is shown in greater detail in FIG. 5, with reference to sockets 502-506. Builder 310-1 may then use XML, JSON, native system solutions or any other known medium to interchange data with the data source (shown in FIG. 5 as IoT devices 122 (or a gateway to an IoT network), applications 202, and/or a UI 335). Builders 310 can be listeners (TCP/UDP sockets setup as listeners for data being pushed to them, by listening for a push operation or an alert, notification, or message from the IoT device or an IoT gateway), pullers (by pulling information from web-services (via JSON or XML), obtaining information on a real-time, scheduled or periodic basis), and/or may other tie in with remote or otherwise disparate or discrete system transactional managers.

In one exemplary embodiment, an IoT device D1 may be an environmental health and safety device that records an event each time a movement is sensed under a motion sensor. Given a certain number of sensor reads, event data is stored in a data log for the given sensor device D1. Similar or different data (different, e.g., in format, data type, data size, etc.) may be collected by devices D2 and D3, which need not be the same type of sensors. Prior to data collection, a blockchain 320 may be created (e.g., by building logic 140-1), with no data blocks or storage in memory. As data is collected on the device D1, the data may be transmitted in real time (or on a scheduled or periodic basis) via a TCP socket connection established by builder 310-1, and such data may ultimately be stored on the blockchain. Data from devices D2 and D3 may be collected similarly. In the illustration of FIG. 3, data relating to four reads for device D1, four reads for device D2, and four reads for device D3 are stored on the blockchain 320, though such numbers are merely exemplary and any number of reads and/or data may be stored in different embodiments. Blockchain 320 now contains a series of sets of data associated with the various different devices with whom a socket connection has been established. That is, different sensor data (or other IoT or device data) from different devices is aggregated together in the blockchain 320 agnostic to where the data comes from.

In other embodiments, data can additionally or alternately be input via one or more user interfaces (e.g., via a website) and added to the blockchain in real-time. In some embodiments, prior to adding data blocks in the blockchain, the builders 310 may store collected data in one or more transaction logs (or event logs) in memory 140, separate from the blockchain memory. In other embodiments, the data for each devices is stored in individual transaction logs at each respective device, and builder 310-1 (or another respective builder) may pull data from that log in real-time and/or on a scheduled or periodic basis, or when triggered by an event or action. The builder may then store the relevant information on the blockchain and/or in one or more non-blockchain storages (e.g., in storage 525 via storage server 520 as shown in FIG. 5). In still other embodiments, in addition to storing on the blockchain and/or in a central memory, a builder 310 may also transmit the data to another location (whether on or remote from system 110), such as to a redundant storage (external), to the cloud, to learners (e.g., neural network 226) or other components or devices, or to one or more devices or entities desiring to receive the detailed event log data.

In one embodiment where the builders 310 generate a centralized transaction log (shown in FIG. 5 as log 540), the transaction data from the devices may be organized into tables or records. A builder 310 may keep track of tables and records for persistence of data. These tables and records may include various information in different embodiments, including but not limited to one or more of: the type of event or action, the name and path in the file store at the device, a timestamp indicating when the event log was generated. Transactions may be assigned a title (e.g., “data modified”, “tagged”, or “tagged to” fields) and/or an action (e.g., insert, update, or delete), where titles and actions correspond to system-defined characteristics or fields of the device D1, D2, D3, etc. In some embodiments, multiple tables and records may be created to allow the storage of nested information, or information associated with each other at various hierarchical levels. While the tables and/or records may be designed to correspond to the format of data as defined at its origin device or entity, in other embodiments, builders 310 may perform formatting and/or other calculations to conform the data for storage, to conform with other entries, and/or to fit within a defined data size of the blockchain.

In some embodiments, the tables/records may include a hash value generated for the transaction log or the record or individual transaction or event (e.g., a hash of the bytes making up the content of the event or log, e.g., using the MD5 hash algorithm or any known method of hashing). The builder 310 then creates a blockchain transaction recording those details, including the hash value, and adds the transaction to the blockchain 320. The blockchain may be stored (or additionally stored) in blockchain storage 144. The builder 310 is a trusted component; a non-trusted individual or program with malicious intent would not be able to alter the transaction or event data without the fact that they have done so being evident in the blockchain data.

For purposes of example, an embodiment may exist where the data on the devices is directed to inspection data, where the data may include, e.g., inspection type, comments, date/time of inspection, description, inspector, etc. The inspection data may also be tagged with other relevant information, such as later-derived measurement or calculation data, risk data, and the like. Of course, the embodiments are not limited to the foregoing and the particular data collected by the systems is defined by platform 210 or another system-facing mechanism to collect data appropriate to the application at hand (e.g., risk management). Similarly, tuning rules and parameters for the stored data can be set up based on the needs for retrieval of data, such as a number of blocks to be stored in memory, automated adjustments to the data (e.g., based on data type and/or use), the length and/or permanency of storage (whether the blockchain need not be retained for long periods in memory, and may instead be swapped out), the location of storage (e.g., temporary/limited/permanent, local/remote), a number of blocks allowed to be restored to memory, an inactive reader time limit (based on number of open readers restoring blocks), whether it is an IoT blockchain, whether to encrypt the chain information, and/or any other appropriate metric or classification.

In the exemplary embodiment, multiple blockchains are created, each tied to at least one transaction manager via respective TCP/UDP sockets. For instance, each of apps 202 available through platform 210 may require different information from the devices 122, and therefore, each app 202 may create its own blockchain 320 that ties into the same transaction manager. For instance, an embodiment may exist where the data on the devices is directed to inspection data and each separate inspection is managed via a different blockchain 320.

The architecture described herein provides mechanisms to ensure data integrity, accountability for changes, and communication between computing nodes. Initially, the use of a blockchain makes the data stored thereon immutable from the content added by the trusted source, to identify data that has been and prevent data from being modified by an outside or untrusted source. The blockchain stores all data from the builders collected from the IoT devices in the format and to the level of completeness as was transmitted by the individual devices, such that the blockchain may be comprised of blocks with variable length blocks and variable number of transactions. That is, the blockchain is not limited to a set amount or configuration of nodes.

In some embodiments, the initial building node 310 of the blockchain may only store limited amount of data on the blockchain, the initial block being very lightweight for purposes of transmitting and starting the chain. In a conventional application, each subsequent block in a blockchain must be secured by the application of a consensus protocol, such as a proof of work, proof of useful work, proof of stake, or the like. However, in the architecture described herein, consensus to add a block to the blockchain is only necessary between the various builders 310, and can therefore be more easily reached without the use of a proof of work or the like. Finalization of the added block can be set by the system 110 based on node configuration and percentage desired, and may vary due to the number of nodes within the network.

It can be generally understood that the blockchains generated by the blockchain data mining component 230 do not function as the data storage backend of the system 110 but are instead tied into the existing transaction managers of the devices 122 and/or the apps 202 provided by the platform 210. The builders 310 act as data producers that generate transactional logs and/or logs of data 540 from IoT devices 122 or any data services or devices, in centralized and decentralized systems. In other implementations, rather than builders 310-1, 310-2, 310-3 customized for each of the devices 122, blockchain 320 can be built from any data source that produces detailed logs, and no additional data source is created by the builders 310. By these means, the blockchain data mining component 230 co-exists with systems already provided by platform 210.

As can be seen in FIG. 3A, blockchain data mining component 230 may further comprise one or more crawling modules (crawlers) 330-1, 330-2, 330-3 (individually and collectively referred to as crawlers 330) that function on top of blockchain(s) 320. Though three crawlers are illustrated for ease of reference, any number may be used in different embodiments. Multiple crawlers 330 can exist on a single chain and the crawlers 330 thereon may constantly organize the data on that chain, pulling records or transaction-based information, and organizing that data into tables and records like a traditional database. Through this process, the data on the blockchain is time-capsuled by the crawlers in an automated fashion, so that a user or entity querying the blockchain can see a record at any point in time (not just the current version) and obtain complete (or partial) historical audit trails for every change made to any record. The crawlers 330 organize the data in blockchain 320 into database-like structures that can be searched upon in accordance with one or more system-defined rulesets (defined by system 110 or via platform 210) to collect a set of transaction information. In the embodiment of FIG. 3A, each crawler corresponds to one ruleset, though such is merely exemplary and any number or configuration of rules can be applied in various embodiments.

Crawlers 330 further function to create sockets to multicast information for dashboards, assistants, and/or artificial intelligence solutions (AI) (illustrated in FIG. 3A as UI 335, though it is not so limited) and pull information about historical records collected from the blockchain via JSON/XML or other mechanisms. While only one blockchain is illustrated in FIG. 3A, a plurality of blockchains may variously exist in other embodiments, and the crawlers 330 on those blockchains may contain intelligence sufficient to communicate with each other to aggregate datasets and generate comprehensive query results across multiple blockchains. A blockchain 320 is stored and replicated across many nodes, and may also be stored in one or more centrally located databases. However, crawlers 330 may also pull data from the blockchain and create human-readable table-like data to deliver to the user.

In some embodiments, crawlers 330 may, as part of their organization of the blockchains, confirm that blockchain data is in sync with system data, for example, that the format or the timestamp of the data on the chain matches the currently-defined system rules. By these means, the crawlers 330 can determine when data is modified or attempted to be modified outside of set system processes. In some embodiments, smart contracts (machine-readable instructions that can store information) may also be stored as events or code on the blockchain, these smart contracts acting as a mechanism to administer or enforce system-defined rules. When executed at a node (or, e.g., a virtual machine), the smart contract may communicate to and from entities at the node, updating the stored information. In some embodiments the crawlers 330 can determine whether one or more smart contracts set at a system-level are followed.

In contrast to a wholly database-oriented solution, the crawler architecture described herein can organize data on the blockchain without setting up any schemas, keys, integrity, and rules that would be necessary to make sense of complex databases. Because data on the blockchain is immutable (unchangeable), including only create and/or read actions, the crawlers contain a full life cycle or version of all organized data. Further, while redundancy of the blockchain (or the data thereon) may be introduced in certain embodiments (e.g., based on system-specific requirements and/or regulatory requirements of data storage in different industries), unlike conventional databases, no redundancy in tables is strictly needed. Therefore, no changes or additions to the programming of the extant apps 202 are needed when introducing the blockchain architecture, as would be needed for a database-driven solution. However, even without the overhead of performing such tasks, the functionality of the blockchain allows for at least the same capabilities of, e.g., a database with temporal tables.

In the illustration of FIG. 5, multiple crawlers 330-1, 330-2 are attached to blockchain 320 as individual node crawlers. However, embodiments may exist where only one or several crawlers are attached to the blockchain. For instance, in the case of decentralized crawlers, crawlers 330 can be given multiple chains to pay attention to, and/or may be instructed (by the crawling logic 142-2) to pay attention to other remote crawlers. Further, embodiments may exist where crawlers 330, rather than existing as discrete components, functioning to pull information from the blockchain 320 by either attaching to a builder, being setup as an individual node crawler, or attaching to another crawler.

Each crawler 330 may apply one or more rulesets defining data to be searched for, although in alternate embodiments (e.g., where not all data is stored on the blockchain or the data is auto-tuned or refined by the builders based on the intended use) no rules may exist. In embodiments where rulesets are defined for crawlers, the rules reflecting those rulesets may vary. For example, a ruleset for a crawler 330-1 may include any one or more of: criteria to partition data on the blockchain to be searched for, criteria to partition data on the blockchain to be transmitted via sockets, such criteria potentially including: record quantity (on the blockchain) or size limit in memory, record timeframe/timestamp, in crawler time length, IDs of fields to be stored in memory, IDs of fields to be retrieved and transmitted via JSON/XML, IDs to be used to build keys (e.g., IoT device ID) to see current and/or historical data, store key indexes (building heat maps around keys)), event or transaction type, event or transaction name, device location (within certain buildings, within certain radius, from GPS location maintenance delay/status, etc.), maintenance parameters (e.g., how often maintenance is performed), triggers for one or more recognized problems or faults, among others. In some embodiments, the crawlers 330 act in real time to crawl the blockchain upon entry of a query, and in other embodiments, the crawlers search against historic records separately from any real-time analysis. As one example, a ruleset for a crawler may define that, in obtaining information, the crawler should focus on certain types of data, such as a time frame of interest (between two dates, every recurring weekend, etc.), or data that meets any of a variety of criteria. As another example, a ruleset for a crawler may ask for a collection of all critical faults that have occurred at the relevant IoT devices, within or without a time range. This application of different criteria allows decentralization of data organization for data security and to address various system needs. That is, the crawler 330 is aggregating data from the chain 320 in a certain ways such the system can use the crawler to build information (based on triggers) to be transmitted, using one or more default defined rulesets.

Data can be retrieved from the crawlers 330, through, for example, the use of Javascript event describers/event listeners 364 that point to a specific crawler(s). The event describers 364 are tuned (viz., set or filtered) to focus on particular events, such as whether a record being built by the crawlers meets a set criteria. When such criteria is met, the event describers 364 may collect the “hit” data and push the information gained to a socket 372, thereby creating one or more spinoff blockchains 550 (FIG. 5). A spinoff blockchain may be criteria-specific, filtered to include only transactions or events for which the identified criteria is met. To accomplish this, each crawler 330 may have one or more builders 310, where, in some embodiments all builders on each crawler must reach consensus to add blocks while building, finalizing, and deploying the spinoff blockchain 550.

Because the data is organized into readable records, data can be broadcast to dashboards, learning modules, assistants, and the like and viewed by human or machine actors. A crawler may use a multi-caster (or broadcaster) 356 (FIG. 3B) to broadcast this information to any listener via sockets, such as web sockets for dashboards or TCP sockets for assistants, learning modules, or AI solutions. In an exemplary embodiment, a multi-caster is assigned to a crawler on a 1-to-1 basis, however other embodiments may differ. In some embodiments, a multi-caster is set for each crawler as needed, and is unassigned (or expires or disappears) when all connections for the crawler have been lost. A multicaster 356 may contain multiple sockets. In some embodiments web sockets 352 can be formed (from web/mobile apps to crawlers) via permission requests to a gateway or other network device. Multicaster 356 may additionally or alternately form TCP and/or UDP Sockets 354 (e.g., for assistants, notifiers, and AI) via a controller (not specifically shown) or in a batch process performed at a node. These various pipes (sockets) may be created automatically (that is, in an automated manner without intervention by users, devices, or apps) via appropriate permission and handshake procedures.

Multi-casters 356 are notified by the crawler 330 every time data is processed from the blockchain 320 that meets the criteria of the crawler 330, after which notification the multi-caster attempts to transmit the data to all of its created sockets. The specifics of transmission can be tuned or set by the system 110 based on the needs of the relevant app 202. As one example, socket timeouts or expirations can be defined and upheld.

In an exemplary embodiment, a representational state transfer (REST) API 360 may also be used to pull information from a crawler in response to a query, message, or request from a UI 355 and/or app 202. The pulled information may include all record information or a subset thereof, subject to, e.g., certain criteria and/or time frame. By limiting the date/time to a certain timeframe, a versioned version of the records can be obtained. Other embodiments may use other APIs (e.g., SOAP, etc.) to pull information about data transactions or records and to version each record.

Data may be published on the blockchain by a publisher (not specifically shown) implemented to point to a crawler 330 and to publish a user interface or graphical user interface with the crawler's data and/or the crawler's data that is on the spinoff blockchain created by the crawler 330 and the event describer 364. The publishing may be done with indexing and analytics, allowing complete table and record breakdown showing relevant time-capsuled data. User interface (UI) 335 may be any interface (in some embodiments generated and/or delivered via the platform 210 or through a reporting service 530 (FIG. 5)) that allows a user or a system to interact with the data from the blockchain and/or data of the spinoff blockchain. For example, the UI 335 may include one or more visualization components that generate different graphical user interfaces (GUIs) based on the current blockchain objects, the previous (historical) data of the blockchain objects, possible actions or events that can be derived based on the stored data of the blockchain objects, and the like. In one example, the user interface 335 may be a web browser application that allows for interaction by a user of a computing device.

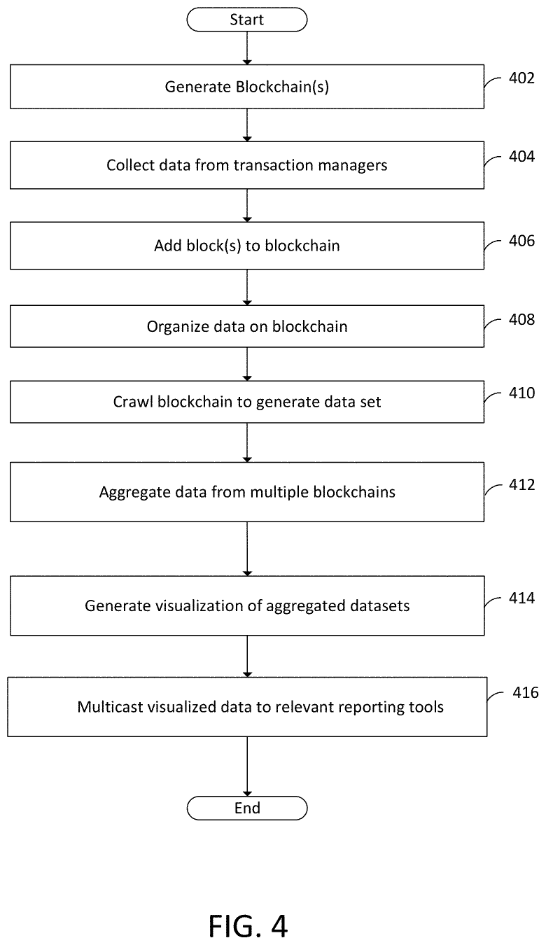

FIG. 4 illustrates a flowchart of a process performed by blockchain data mining module 230, in accordance with some embodiments. In an exemplary embodiment, Steps 402-406 are performed by building logic 142-1 and Steps 408-416 are performed by crawling logic 142-2, though any of these steps (or any subset or combination thereof) may be performed by different logics or modules (whether local or remote to system 110) in different embodiments. The process begins at Step 402, at which a blockchain is generated. The individual blocks for this blockchain are generated based on extant data, previously stored or concurrently being stored in one or more detailed transaction logs or event logs at one or more devices. In one embodiment, a transactional log is generated based on data collected from the respective transaction managers of one or more IoT devices (Step 404), however in other embodiments, the devices (or any subset thereof) may already maintain detailed transaction logs, in which case such logs may be transmitted to the builders in their existing state. In Step 406, at least one block is generated by a builder for addition to the blockchain, based on the transaction/event data obtained from the device(s). The particular form and size of the block is highly dependent on the content of the obtained data and/or system-specific rules set by system 110. In an exemplary embodiment, the blockchain is agnostic to the device from which the data is received, such that data originating from any of several IoT devices may be stored on a single blockchain. In Step 408, data on the blockchain is organized by one or more crawlers dedicated to that blockchain, so as to be structured in tables and automatically time-capsuled. In response to a query or request from a user (or an app via platform 210), the crawlers crawl all existing blockchains (or a subset thereof) to find blocks containing data meeting specified criteria relevant to or specified in the query (Step 410). The existing chains may communicate with each other in order to generate aggregated data in support of the query, and the resultant data is collected (or aggregated) into a new dataset stored on a spinoff blockchain (Step 412). In response to a user requested presentation of the blockchain data via a UI, the system 110 may generate a visualization of the data on the spinoff blockchain (Step 414). This visualization may take a particular format based on the criteria for the data, the user ID or type, the size and range of the data, system or industry standard reporting, or any other appropriate restrictions or limitations on format. This visualized data may be transmitted, via web sockets or TCP/UDP sockets, to a plurality of destinations (reporting tools) via broadcast or multi-cast transmission (Step 416), such as dashboards, reports, learning modules, AIs/assistants, and the like.

In conventional solutions, systems may use the blockchain to implement accountability for, detail about, and visibility into current and historic stored data. To accomplish this, conventional blockchain implementations use the blockchain as the system's backend, in replacement of a centralized database. However, use of a blockchain as the system's backend is extremely difficult in an enterprise environment, requiring extensive set up, and the creation of private nodes that must be kept private from third parties, such as suppliers.

Being there are only create and read operations on blockchains, they provide a solution that may be particularly useful in systems requiring accountability or utilizing IoT devices such as sensors or medical devices. With the solutions and methods described herein, the blockchain does not function as a system backend and therefore, the entire content of the blockchain does not need to be stored in memory, therefore removing or mitigating the need to store millions of nodes or records, let alone redundant records. Rather, the blockchain communication architecture is being used on top of or in conjunction with existing systems to provide historical record information, warnings, or messages regarding changes in data state, assuring proper processes and channels are utilized, and/or aggregating information from IoT devices. By these means, a user can have accurate, trusted information off the blockchain that can be analyzed in real-time, instantaneously, periodically, or historically that does not need to be stored typically or versioned in a database.

Further, the solutions herein permit implementation over small private networks, where consensus is reached quickly, for example, by a limited number of known, trusted building components. Further, on a private network, finalization becomes a simple matter due to the fault tolerance levels within the network permitting relatively low acceptance rates to achieve finalization of a block. By these means, the labor and resource intensive proof of work functions required for a traditional blockchain implementation are rendered irrelevant.

The present solutions provide substantial improvements over existing systems, particularly in enterprise implementations. By the systems described above, the blockchain is built around an existing system's variable length data and needs, reducing the need for complex custom code for different applications. Additionally, existing industry systems do not have to be programmed (or reprogrammed) around a backend blockchain; instead, the blockchain structure is designed flexibly to automatically adjust to the system, where the system creates the information needed in the blockchain. Further, the solutions herein permit crawling of the blockchain to collect data meeting particular criteria, through the generation of multiple blockchains that communicate with each other to aggregate and filter their content. Still further, the multiple blockchains in the present solution aggregate data from a variety of different data sources, and communicate desired portions of that aggregated data to all necessary recipients, whether via dashboard, learning modules, assistants, or any other existing system(s).

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A blockchain communication system comprising:
a memory; and
one or more processing units configured to execute instructions stored in the memory to perform steps comprising:
establishing a socket connection with a transaction manager of a remote device;
receiving, from the transaction manager, via the socket connection, event data;
determining, based on the received event data, a characteristic of a blockchain object;
generating a blockchain object based on the determined characteristic and the received event data; and
deploying the blockchain object to a blockchain.

2. The blockchain communication system of claim 1, wherein the determined characteristic comprises one or more of: a block length, a number of blocks, a number of transactions per block, a storage duration, and an encryption setting.

3. The blockchain interface system of claim 1, wherein the socket connection is a TCP/UDP socket configured to listen for data being pushed from the remote device.

4. The blockchain communication system of claim 1, wherein the one or more processing units are further configured to execute instructions stored in the memory to perform steps comprising:
organizing data on the blockchain based on one or more predetermined criteria;
crawling the blockchain to identify one or more transactions meeting the one or more predetermined criteria;
generating a criteria-specific blockchain object based on the identified one or more transactions;
deploying the criteria-specific blockchain object to a criteria-specific blockchain; and
transmitting data from the criteria-specific blockchain via one of: a broadcaster or a multi-caster.

5. The blockchain communication system of claim 4, wherein the one or more processing units are further configured to execute instructions stored in the memory to perform steps comprising:
removing, from a memory, the blockchain.

6. The blockchain communication system of claim 4, wherein the one or more processing units are further configured to execute instructions stored in the memory to perform steps comprising:
publishing data from the criteria-specific blockchain via one or more web sockets or one or more TCP/UDP sockets.

7. The blockchain communication system of claim 4, wherein the one or more predetermined criteria comprises one or more of: timeframe, timestamp, device ID, event type, event name, and location.

8. The blockchain communication system of claim 1, wherein the one or more processing units are further configured to execute instructions stored in the memory to perform steps comprising:
establishing a second socket connection with a second transaction manager of a second remote device; and
receiving, from the second transaction manager, via the socket connection, event data of the second remote device;
wherein the generating of the blockchain object is based on the determined characteristic, the received event data from the remote device, and the received event data of the second remote device.

9. The blockchain communication system of claim 1, wherein the remote device is a sensor device, and
wherein the generating of the blockchain object is performed in a manner agnostic to the identity of the sensor device.

10. A method of transmitting information on a blockchain, the method comprising:
establishing, by a builder module of a computing system, a socket connection with a transaction manager of a remote device;
receiving, by the builder module from the transaction manager, via the socket connection, event data;
determining, by the builder module, based on the received event data, a characteristic of a blockchain object;
generating, by the builder module, a blockchain object based on the determined characteristic and the received event data; and
deploying, by the builder module, the blockchain object to a blockchain.

11. The method of claim 10, wherein the determined characteristic comprises one or more of: a block length, a number of blocks, a number of transactions per block, a storage duration, and an encryption setting.

12. The method of claim 10, wherein the socket connection is a TCP/UDP socket configured to listen for data being pushed from the transaction manager.

13. The method of claim 10, further comprising:
organizing, by a crawler module of the computing system, data on the blockchain based on one or more predetermined criteria;
crawling the blockchain, by the crawler module of the computing system, to identify one or more transactions meeting the one or more predetermined criteria;
generating, by the crawler module of the computing system, a criteria-specific blockchain object based on the identified one or more transactions;
deploying, by the building module fo the computing system, the criteria-specific blockchain object to a criteria-specific blockchain; and
transmitting data, by the crawler module of the computing system, from the criteria-specific blockchain via one of: a broadcaster or a multi-caster.

14. The method of claim 13, further comprising:
removing, by the computing system, from a memory, the blockchain.

15. The method of claim 13, further comprising:
publishing data, by one of the broadcaster or the multicaster, from the criteria specific blockchain via one or more web sockets or one or more TCP/UDP sockets.

16. The method of claim 13, wherein the one or more predetermined criteria comprises one or more of: timeframe, timestamp, device ID, event type, event name, and location.

17. The method of claim 10, further comprising:
establishing, by the builder module, a second socket connection with a second transaction manager of a second remote device; and
receiving, by the builder module from the second transaction manager, via the second socket connection, event data of the second remote device;
wherein the generating of the blockchain object is based on the determined characteristic, the received event data from the remote device, and the received event data of the second remote device.

18. The method of claim 10, wherein the remote device is a sensor device, and
wherein the generating of the blockchain object is performed in a manner agnostic to the identity of the sensor device.

19. A method comprising:
establishing, by a builder module of a computing system, a first socket connection with a first transaction manager of a first remote device;
establishing, by the builder module, a second socket connection with a second transaction manager of a second remote device;
receiving, by the builder module from the first transaction manager, via the first socket connection, first event data of the first remote device;
receiving, by the builder module from the second transaction manager, via the second socket connection, event data of the second remote device;
determining, by the builder module, based on at least one of the received event data of the first remote device and the received event data of the second remote device, a characteristic of a blockchain object;
generating, by the builder module, a blockchain object based on the determined characteristic, the first event data, and the second event data; and
deploying, by the builder module, the blockchain object to a blockchain.

20. The method of claim 19, further comprising:
organizing, by a crawler module of the computing system, data on the blockchain so as to organize the data into a table structure;
crawling the blockchain, by the crawler module of the computing system, to identify one or more transactions meeting one or more predetermined criteria;
generating, by the crawler module of the computing system, a criteria-specific blockchain object based on the identified one or more transactions;
deploying, by the building module fo the computing system, the criteria-specific blockchain object to a criteria-specific blockchain; and
transmitting data, by the crawler module of the computing system, from the criteria-specific blockchain to one or more socket connections.
